(19) United States
(12) Patent Application Publication
(10) Pub. No.: US 2024/0022124 A1
(43) Pub. Date: Jan. 18, 2024

(54) ROTATING ELECTRIC MACHINE

(71) Applicant: DENSO CORPORATION, Kariya-city, Aichi-pref. (JP)

(72) Inventor: MASAHIRO SEGUCHI, Kariya-city (JP)

(21) Appl. No.: 18/350,537

(22) Filed: Jul. 11, 2023

(30) Foreign Application Priority Data
Jul. 14, 2022 (JP) 2022-113509

(51) Int. Cl. H02K 1/26; H02K 15/095; H02K 15/02

(52) U.S. Cl. CPC H02K 1/26; H02K 15/095; H02K 15/026; H02K 2213/03

(57) ABSTRACT

A rotating electric machine includes a rotor, main pole portions, and a field winding. A center axis of the main pole portion extending in a radial direction passing through a rotation center axis of the rotor is defined as a first axis, an axis passing through a center position of the first axis adjacent in the circumferential direction and a rotation center axis and extending in a radial direction is defined as a second axis, and an axis passing through a center position of the first axis and the second axis that are adjacent in the circumferential direction and the rotation center axis and extending in the radial direction is defined as a third axis. An outer end portion of the field winding in the circumferential direction in each of the main pole portions is positioned between the second axis and the third axis in the circumferential direction.

### CROSS REFERENCE TO RELATED APPLICATION

The present application is based on Japanese Patent Application No. 2022-113509 filed on Jul. 14, 2022, disclosure of which is incorporated herein by reference.

### TECHNICAL FIELD

The present disclosure relates to a field winding type rotating electric machine.

### BACKGROUND

Conventionally, a field winding type rotating electric machine is known that includes a stator and a rotor having a field winding.

### SUMMARY

A field winding type rotating electric machine includes a stator, a rotor having a rotor core and main pole portions that are provided at predetermined intervals in a circumferential direction and protrude radially from the rotor core toward the stator, and a field winding wound around each main pole portion.

A center axis of the main pole portion extending in a radial direction passing through a rotation center axis of the rotor is defined as a first axis, an axis passing through a center position in the circumferential direction of the first axis adjacent in the circumferential direction and the rotation center axis and extending in a radial direction is defined as a second axis, and an axis passing through a center position in the circumferential direction of the first axis and the second axis that are adjacent in the circumferential direction and the rotation center axis and extending in the radial direction is defined as a third axis.

An outer end portion of the field winding in the circumferential direction in each of the main pole portions is positioned between the second axis and the third axis in the circumferential direction.

### BRIEF DESCRIPTION OF DRAWINGS

FIG. 1 is an overall configuration diagram of a control system for a rotating electric machine according to a first embodiment;

FIG. 2 is a diagram showing an inverter and its peripheral configuration;

FIG. 3 is a cross-sectional view of a rotor;

FIG. 4 is a diagram showing an electric circuit in the rotor;

FIG. 5 is a flow chart showing a manufacturing process of the field winding;

FIG. 6 is a diagram showing an air-core coil set in a press molding device;

FIG. 7 is a diagram showing a state before the air-core coil is compressed in a first pressing process;

FIG. 8 is a diagram showing a state after the air-core coil is compressed in the first pressing process;

FIG. 9 is a diagram showing a state before the air-core coil is compressed in a second pressing process;

FIG. 10 is a diagram showing a state after the air-core coil is compressed in the second pressing process;

FIG. 11 is a view showing a state in which a rectangular wire is wound around an outermost layer in a third pressing process;

FIG. 12 is a diagram showing a state before the air-core coil is compressed in the third pressing process;

FIG. 13 is a diagram showing a state after the air-core coil is compressed in the third pressing process;

FIG. 14 is a diagram showing an insertion of the air-core coil into the main pole portion;

FIG. 15 is a diagram showing an attachment of a collar portion to the main pole portion;

FIG. 16 is a diagram for explaining contact ratios of rectangular wires;

FIG. 17 is a diagram showing an insertion of the air-core coil according to a modification of the first embodiment into the main pole portion;

FIG. 18 is a diagram showing an attachment of the main pole portion to the rotor core according to the modification of the first embodiment;

FIG. 19 is a diagram showing part of the field winding according to a second embodiment;

FIG. 20 is a cross-sectional view along line XX-XX of FIG. 19;

FIG. 21 is a view of the field winding in FIG. 19 viewed from the main pole portion side;

FIG. 22 is a diagram showing a state before the air-core coil is compressed in the first pressing process;

FIG. 23 is a diagram showing a state after the air-core coil is compressed in the first pressing process; and

FIG. 24 is a diagram showing a state after the air-core coil is compressed in the second pressing process.

### DETAILED DESCRIPTION

In an assumable example, for example, afield winding type rotating electric machine is known that includes a stator and a rotor having a field winding. The rotor has a rotor core and main pole portions that are provided at predetermined intervals in a circumferential direction and protrude radially from a rotor core toward the stator. The field winding is wound around each main pole portion.

In order to increase an exciting characteristic associated with energization to the field winding, it is necessary to increase a space factor of the field winding in the rotor.

The present disclosure is to provide a field winding type rotating electric machine capable of increasing the space factor of the field winding.

A field winding type rotating electric machine of a first disclosure includes a stator, a rotor having a rotor core and main pole portions that are provided at predetermined intervals in a circumferential direction and protrude radially from the rotor core toward the stator, and a field winding wound around each main pole portion.

A center axis of the main pole portion extending in a radial direction passing through a rotation center axis of the rotor is defined as a first axis, an axis passing through a center position in the circumferential direction of the first axis adjacent in the circumferential direction and the rotation center axis and extending in a radial direction is defined as a second axis, and an axis passing through a center position in the circumferential direction of the first axis and the second axis that are adjacent in the circumferential direction and the rotation center axis and extending in the radial direction is defined as a third axis.

An outer end portion of the field winding in the circumferential direction in each of the main pole portions is positioned between the second axis and the third axis in the circumferential direction.

As a result, it is possible to increase a ratio of the space occupied by the field winding in a space between the main pole portions adjacent in the circumferential direction, thereby increasing the space factor of the field winding in the rotor.

In the field winding type rotating electric machine of a second disclosure, the field winding is configured by multiple windings of the rectangular wires so that the rectangular wires are arranged in the radial direction and the circumferential direction, and in each of the main pole portions, an inclined portion inclined along the second axis is formed at the outer end portion of the field winding in the circumferential direction.

As a result, the space factor of the field windings in the rotor can be further increased while providing electrical insulation between the field windings adjacent in the circumferential direction.

### First Embodiment

A first embodiment of a rotating electric machine according to the present disclosure will be described below with reference to the drawings. A control system including a rotating electric machine is mounted on a vehicle. The rotating electric machine is a driving power source of the vehicle.

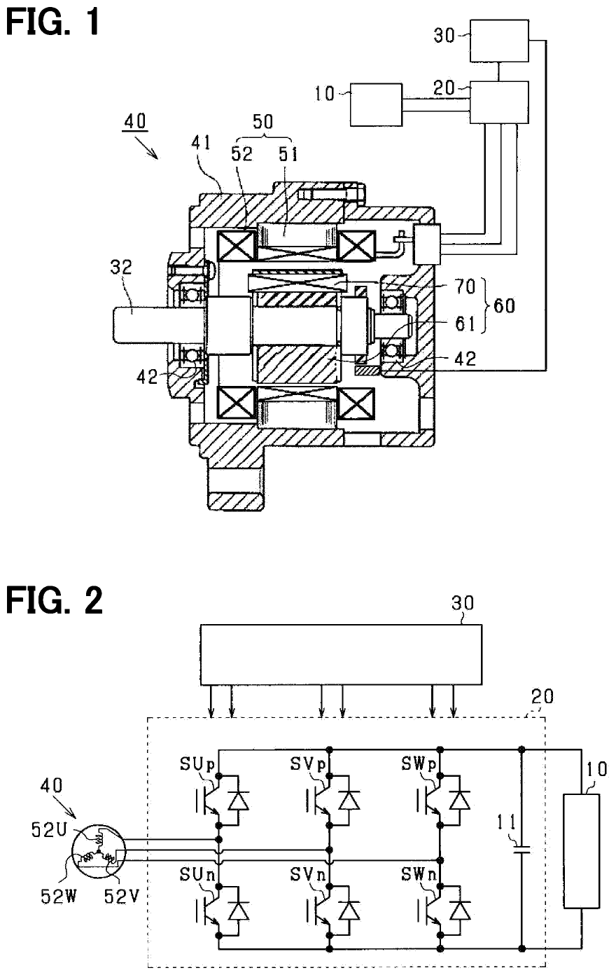

As shown in FIG. 1, the control system includes a DC power supply 10, an inverter 20, a control unit 30, and a rotating electric machine 40. The rotating electric machine 40 is a field winding type synchronous machine. For example, the rotating electric machine 40, the inverter 20, and the control unit 30 are provided to form an electromechanical integrated drive device, or the rotating electric machine 40, the inverter 20, and the control unit 30 are each constituted by respective components.

The rotating electric machine 40 includes a housing 41 and a stator 50 and a rotor 60 that are accommodated within the housing 41. The rotating electric machine 40 of the present embodiment is an inner rotor type rotating electric machine in which the rotor 60 is arranged radially inside the stator 50.

The stator 50 includes a stator core 51 and a stator winding 52. The stator core 51 is made of laminated steel plates made of a soft magnetic material, and has an annular back yoke and a plurality of teeth protruding radially inward from the back yoke. The stator winding 52 is made of copper wire, for example, and includes U-, V-, and W-phase windings 52U, 52V, and 52W arranged with an electrical angle difference of 120 degrees from each other.

The rotor 60 has a rotor core 61 and a field winding 70. The field winding 70 is configured by press molding. As a result, the space factor is improved and an assembling property of the field winding 70 is improved. The field winding 70 may be made of, for example, an aluminum wire. The aluminum wire has a small specific gravity and can reduce a centrifugal force when the rotor 60 rotates. The aluminum wire has lower strength and hardness than the copper wire and are suitable for compression molding. Also, the field winding 70 is not limited to the aluminum wire, and may be, for example, a copper wire or a CNT (carbon nanotube).

A rotating shaft 32 is inserted through a center hole of the rotor core 61. The rotating shaft 32 is rotatably supported by the housing 41 via bearings 42. Both the stator 50 and the rotor 60 are arranged coaxially with the rotating shaft 32. In the following description, a direction in which the rotating shaft 32 extends is defined as an axial direction, a direction extending radially from the center of the rotating shaft 32 is defined as a radial direction, and a direction extending circumferentially about the rotating shaft 32 is defined as a circumferential direction.

As shown in FIG. 2, the inverter 20 is configured by serially connecting U, V, and W phase upper arm switches SUp, SVp, and SWp and U, V, and W phase lower arm switches SUn, SVn, and SWn. First ends of U, V, and W-phase windings 52U, 52V, and 52W are connected to connecting points between U, V, and W-phase upper arm switches SUp, SVp, and SWp and U-, V, and W-phase lower arm switches SUn, SVn, and SWn. The second ends of the U-, V- and W-phase windings 52U, 52V and 52W are connected at a neutral point. That is, in the present embodiment, the U-, V-, and W-phase windings 52U, 52V, and 52W are star-connected. In the present embodiment, each switch SUp to SWn is an IGBT. A freewheel diode is connected in anti-parallel to each of the switches SUp to SWn.

A positive terminal of a DC power supply 10 is connected to the collectors of the U-, V-, and W-phase upper arm switches SUp, SVp, and SWp. A negative terminal of the DC power supply 10 is connected to the emitters of the U-, V-, and W-phase lower arm switches SUn, SVn, and SWn. A smoothing capacitor 11 is connected in parallel with the DC power supply 10.

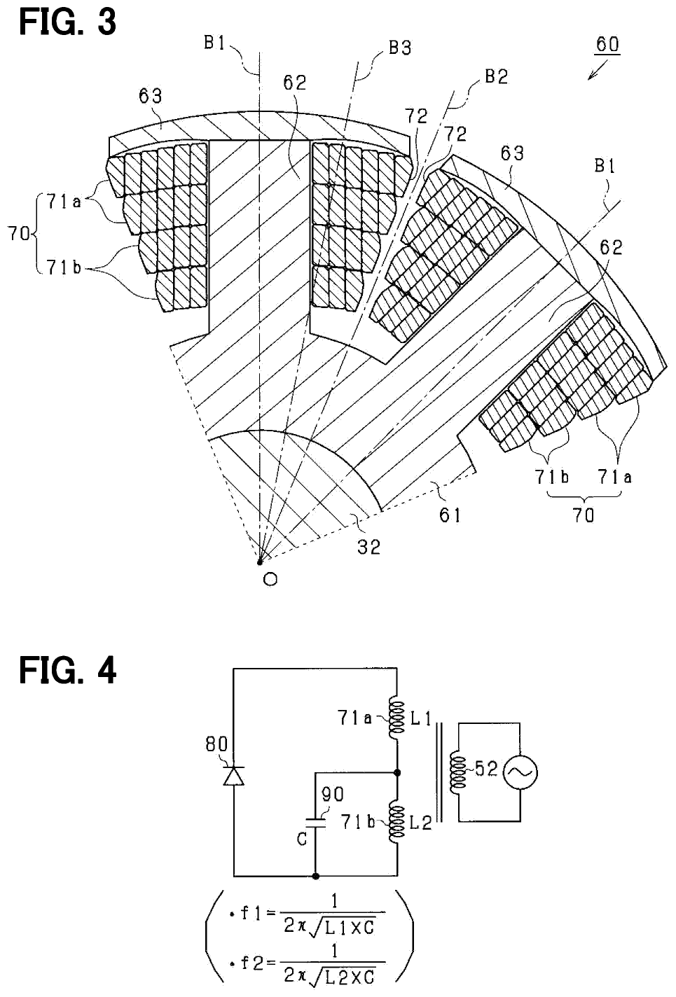

Next, the rotor 60 will be described with reference to FIG. 3.

The rotor 60 is made of a soft magnetic material, and is made of laminated steel plates, for example. The rotor 60 has a cylindrical rotor core 61, a plurality of main pole portions 62 protruding radially outward from the rotor core 61, and flange portions 63 extending radially on both sides from the tip portions of the main pole portions 62. In the present embodiment, the main pole portions 62 are provided at regular intervals in the circumferential direction.

The field winding 70 has a first winding portion 71a and a second winding portion 71b. In each main pole portion 62, a first winding portion 71a is wound radially outward, and a second winding portion 71b is wound radially inward of the first winding portion 71a. In each main pole portion 62, the winding directions of the first winding portion 71a and the second winding portion 71b are the same. Moreover, in the main pole portions 62 adjacent in the circumferential direction, the winding direction of the winding portions 71a and 71b wound on one main pole portion 62 is opposite to the winding direction of the winding portions 71a and 71b wound on the other main pole portion. Therefore, the magnetization directions of the main pole portions 62 adjacent to each other in the circumferential direction are opposite to each other.

FIG. 4 shows an electric circuit on the side of the rotor 60, which includes the winding portions 71a and 71b wound around a common main pole portion 62. The rotor 60 is provided with a diode 80 as a rectifying element and a capacitor 90. A cathode of the diode 80 is connected to the first end of the first winding portion 71a, and the second end of the first winding portion 71a is connected to the first end of the second winding portion 71b. An anode of the diode 80 is connected to the second end of the second winding portion 71b. The capacitor 90 is connected in parallel to the second winding portion 71b. In FIG. 4, L1 indicates the inductance of the first winding portion 71a, L2 indicates the inductance of the second winding portion 71b, and C indicates the capacitance of the capacitor 90.

In the present embodiment, a series resonance circuit is configured by the first winding portion 71a, the capacitor 90 and the diode 80, and a parallel resonance circuit is configured by the second winding portion 71b and the capacitor 90. A first resonance frequency that is the resonance frequency of the series resonance circuit is referred to as f1, and a second resonance frequency that is the resonance frequency of the parallel resonance circuit is referred to as f2. The resonance frequency f1 and the resonance frequency f2 are represented by the following equations (eq1) and (eq2).

[Equation 1]

f1=½π\sqrt{L1*C} (eq1)

[Equation 2]

f2=½π\sqrt{L2*C} (eq2)

Returning to the explanation of FIG. 2, the control unit 30 generates drive signals for turning on and off the switches SUp to SWn that form the inverter 20. Specifically, in order to convert the DC power output from the DC power supply 10 into AC power and supply it to the U-, V-, and W-phase windings 52U, 52V, and 52W, the control unit 30 generates drive signals for turning on and off each of the arm switches SUp to SWn, and supplies the generated drive signals to the gates of each of the arm switches SUp to SWn.

The control unit 30 turns on and off each of the switches SUp to SWn so that the composite current of the fundamental wave current and the harmonic current flows through the phase windings 52U, 52V, and 52W. The fundamental wave current is a current that mainly causes the rotating electric machine 40 to generate torque. The harmonic current is a current that mainly excites the field winding 70 and causes the field current to flow through the field winding 70. The phase currents flowing through each of the phase windings 52U, 52V, and 52W are shifted by an electrical angle of 120°.

A part or all of each function of the control unit 30 may be configured in hardware by, for example, one or a plurality of integrated circuits. Further, each function of the control unit 30 may be configured by, for example, software recorded in a non-transitional substantive recording medium and a computer executing the software.

Next, the field winding 70 will be described with reference to FIG. 3.

The field winding 70 is configured by multiple windings of rectangular wires having a substantially rectangular cross-sectional shape (specifically, a substantially rectangular shape) arranged in the radial direction and the circumferential direction. The rectangular wire is composed of a conductor portion and an insulating layer covering the conductor portion. In the example shown in FIG. 3, the first winding portions 71a forming the field winding 70 are arranged in two rows in the radial direction. In the first winding portion 71a, six rectangular wires in a first layer closest to the stator 50 in the radial direction are arranged in the circumferential direction, and five rectangular wires in a second layer are arranged in the circumferential direction. The second winding portions 71b are arranged in two rows in the radial direction. In the second winding portion 71b, four rectangular wires of a first layer (that is, a third layer of the field winding 70) closest to the stator 50 in the radial direction are arranged in the circumferential direction, and three rectangular wires of a second layer (that is, a fourth layer of the field winding 70) are arranged in the circumferential direction.

As shown in FIG. 3, a central axis of the main pole portion 62 passing through the central axis O of rotation of the rotating shaft 32 of the rotor 60 and extending in the radial direction is defined as a first axis B1. An axis passing through a center position in the circumferential direction of the first axis B1 adjacent in the circumferential direction and the rotation center axis O and extending in a radial direction is defined as a second axis B2. The first axis B1 corresponds to the d-axis, and the second axis B2 corresponds to the q-axis.

An axis passing through a center position in the circumferential direction of the first axis B1 and the second axis B2 that are adjacent in the circumferential direction and the rotation center axis O and extending in the radial direction is defined as a third axis B3. In each main pole portion 62, the outer end portion of the field winding 70 in the circumferential direction is located between the second axis B2 and the third axis B3 in the circumferential direction. As a result, it is possible to increase a ratio of the space occupied by the field winding 70 in the space between the main pole portions 62 adjacent in the circumferential direction, thereby increasing the space factor of the field winding 70 in the rotor 60. Also, by using a rectangular wire with a large cross-sectional area, the resistance value of the field winding 70 can be reduced, the loss in the field winding 70 can be reduced, and the exciting characteristic of the field winding 70 can be enhanced.

In each of the main pole portions 62, an inclined portion 72 inclined along the second axis B2 is formed at the outer end portion of the field winding 70 in the circumferential direction. As a result, it is possible to reduce a distance between the circumferentially adjacent field windings 70 while electrically insulating the circumferentially adjacent field windings 70. As a result, the space factor of the field winding 70 can be further increased.

In the embodiment shown in FIG. 3, there is a gap between the field windings 70 adjacent in the circumferential direction. However, the configuration is not limited to the configuration with a gap. For example, a sheet-shaped insulating member (for example, insulating paper) provided along the second axis B2 may be in contact with outer ends of each of the field windings 70 adjacent in the circumferential direction.

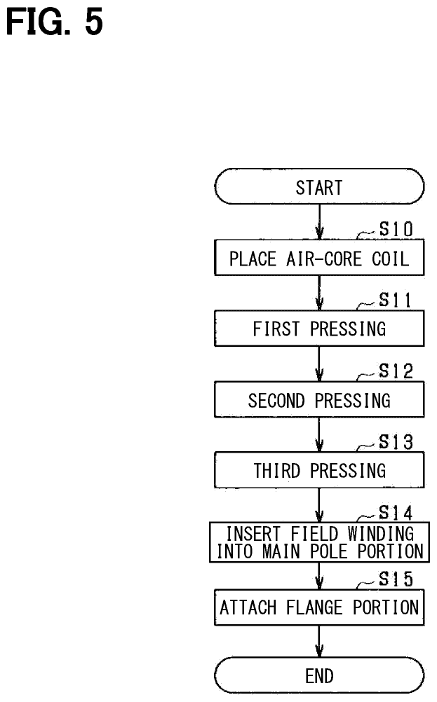

Next, a method for manufacturing the field winding 70 will be described with reference to FIG. 5. In the following, the first winding portion 71a of the first and second winding portions 71a and 71b constituting the field winding 70 will be described as an example.

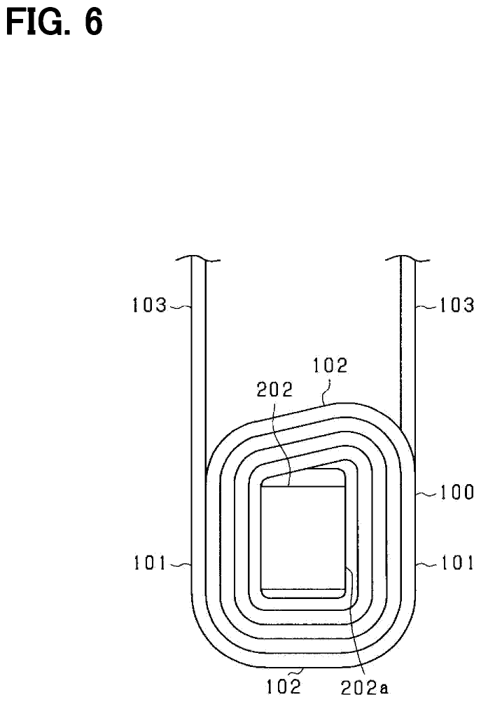

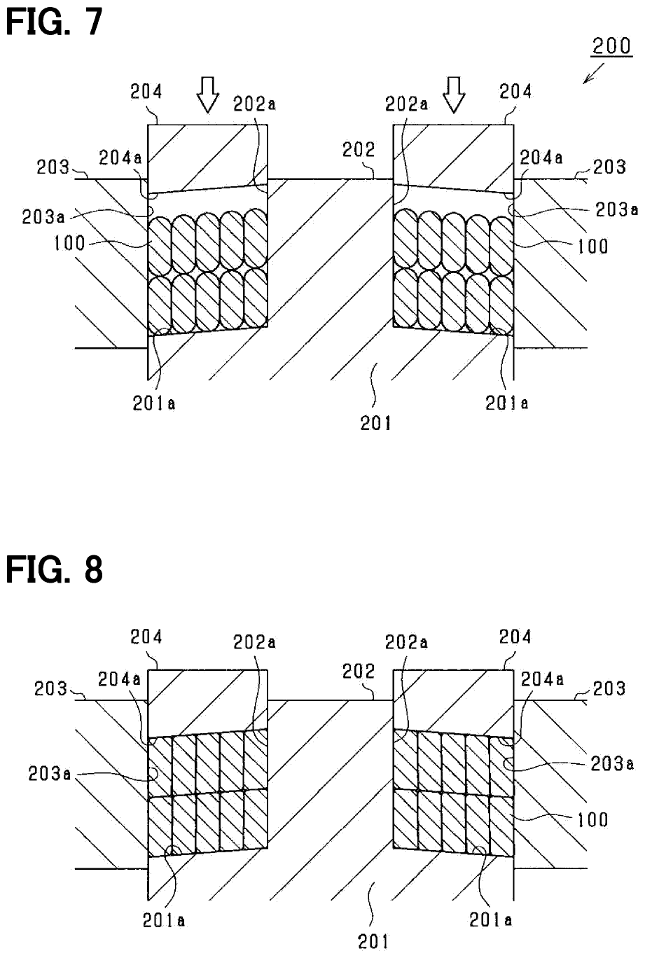

The field winding 70 is manufactured using a press molding device 200. As shown in FIGS. 6 and 7, the press molding device 200 includes a pedestal portion 201 on which an air-core coil 100 as a work is mounted, and a base portion 202 extending upward from a mounting surface 201a of the pedestal portion 201. The base portion 202 has a shape that simulates the main pole portion 62.

As shown in FIG. 6, the air-core coil 100 includes a pair of linear portions 101 that abut against the outer surface (side surface 202a) of the base portion 202 and extend in parallel, and a transition portion 102 that connects the ends of the pair of linear portions 101, and has an annular shape in a plan view. Both ends of the rectangular wire forming the air-core coil 100 are used as winding ends 103. In the air-core coil 100 serving as the first winding portion 71a, not six rectangular wires but five rectangular wires are arranged in the first layer closest to the stator 50 in the radial direction.

As shown in FIG. 5, in step S10, the air-core coil 100 is inserted into the base portion 202, and the air-core coil 100 is placed on the mounting surface 201a (see FIG. 7).

In step S11, a first pressing process (corresponding to a “radial direction pressing process”) is performed to compress the air-core coil 100 in the direction in which the base portion 202 extends. Specifically, an end surface 203a of a first movable die 203 is brought into contact with the outer end of the linear portion 101 that constitutes the air-core coil 100. In this abutting state, as shown in FIGS. 7 and 8, a second movable die 204 compresses the linear portion 101 from above. A pressing surface 204a of the second movable die 204 that is pressed against the air-core coil 100 and the mounting surface 201a of the pedestal portion 201 are inclined surfaces parallel to each other. The inclined surface is to match the shape of the air-core coil 100 with the shape of the flange portion 63 forming the rotor 60. The first pressing process reduces the gap between the adjacent linear portions 101, thereby contributing to the improvement of the space factor.

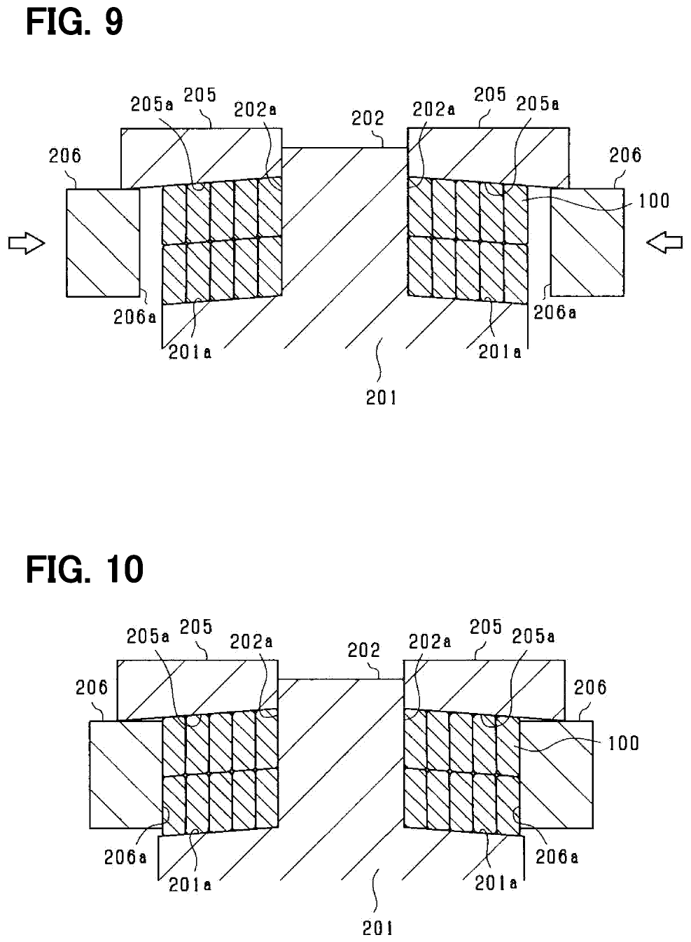

In step S12 of FIG. 5, a second pressing process (corresponding to a “circumferential direction pressing process”) is performed to compress the air-core coil 100 in a direction orthogonal to the side surface 202a of the base portion 202. Specifically, an end surface 205a of a third movable die 205 is brought into contact with the upper surface of the linear portion 101 that constitutes the air-core coil 100. In this abutting state, as shown in FIGS. 9 and 10, a fourth movable die 206 compresses the linear portion 101 from a lateral side. The second pressing process reduces the gap between the adjacent linear portions 101, thereby contributing to the improvement of the space factor.

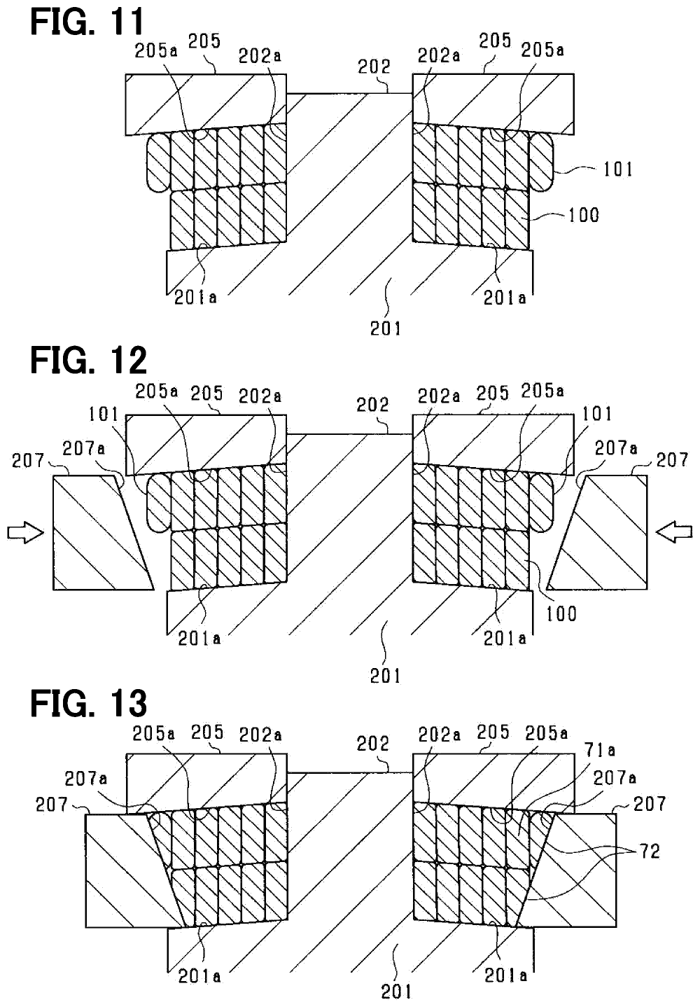

In step S13 of FIG. 5, a third pressing process (corresponding to a “circumferential direction pressing process”) is performed to form the inclined portion 72 at the outer end of the air-core coil 100. Specifically, first, as shown in FIG. 11, by winding a winding end portion 103 of the air-core coil 100 one turn, six rectangular wires are arranged in the first layer closest to the stator 50 in the radial direction.

Then, as shown in FIGS. 12 and 13, in a state in which an end surface 205a of the third movable die 205 is brought into contact with the upper surface of the linear portion 101, the linear portion 101 is compressed from the lateral side by a fifth movable die 207. A pressing surface 207a of the fifth movable die 207, which is pressed against the air-core coil 100, is an inclined surface. This inclined surface forms the inclined portion 72 parallel to the second axis B2 at the outer end of the air-core coil 100. After completing the first to third pressing processes, the press-molded air-core coil 100 is removed from the base portion 202.

An air-core coil that becomes the second winding portion 71b is also press-molded by processes similar to the processes described above.

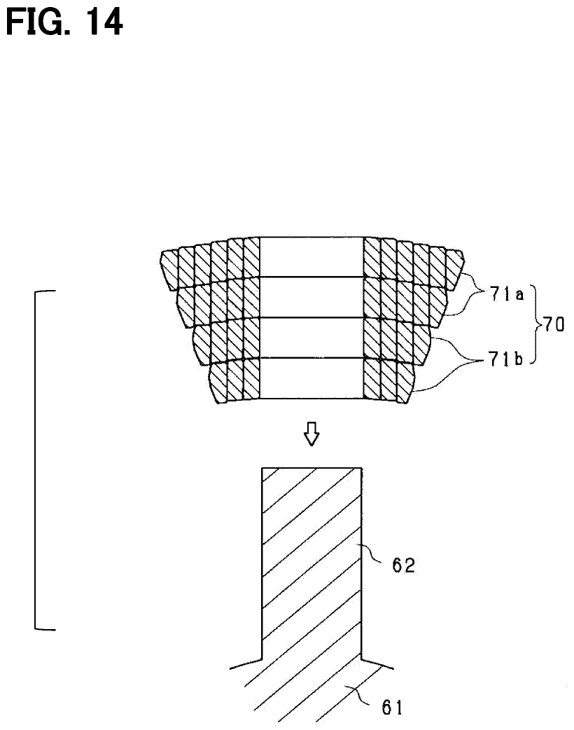

In step S14 in FIG. 5, the field winding 70, which is a press-molded air-core coil, is inserted into the main pole portion 62. As shown in FIG. 14, in the present embodiment, the flange portion 63 and the main pole portion 62 are separate members.

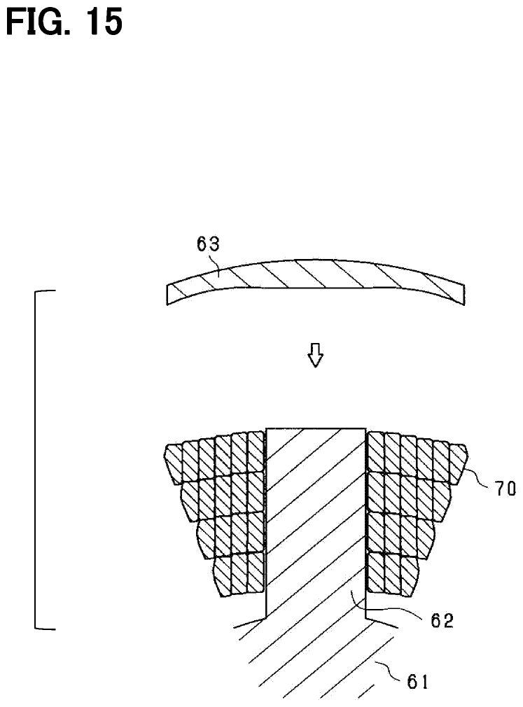

As shown in FIG. 15, in step S15, the flange portion 63 is attached to the tip of the main pole portion 62. Each movable die of the press molding device 200 described with reference to FIG. 5 and each device necessary for the manufacturing processes shown in FIG. 5 are controlled by a controller.

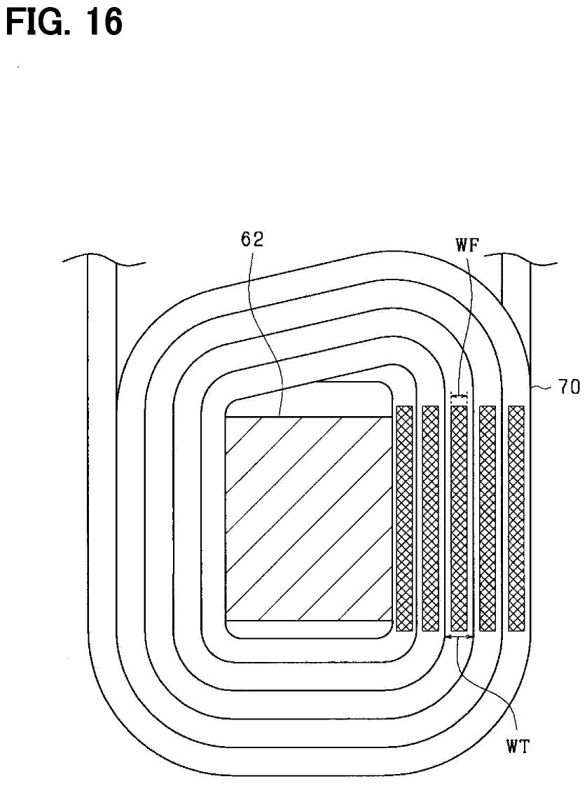

In the field winding 70 consisting of an air-core coil that has undergone the first to third pressing processes, a circumferential length dimension of the contact portion between the rectangular wires adjacent to each other in the radial direction is defined as WF, and a circumferential length dimension of the rectangular wire is defined as WF (see FIG. 16). In this case, in the present embodiment, WF and WT are set so as to satisfy 0.2≤WF/WT<1. As a result, the stress concentration acting on the adjacent rectangular wires is alleviated, and the insulating layer is prevented from being damaged. As a result, a withstand voltage of the field winding 70 can be improved.

According to the present embodiment described above, the space factor of the field winding 70 can be preferably increased.

### Modification of First Embodiment

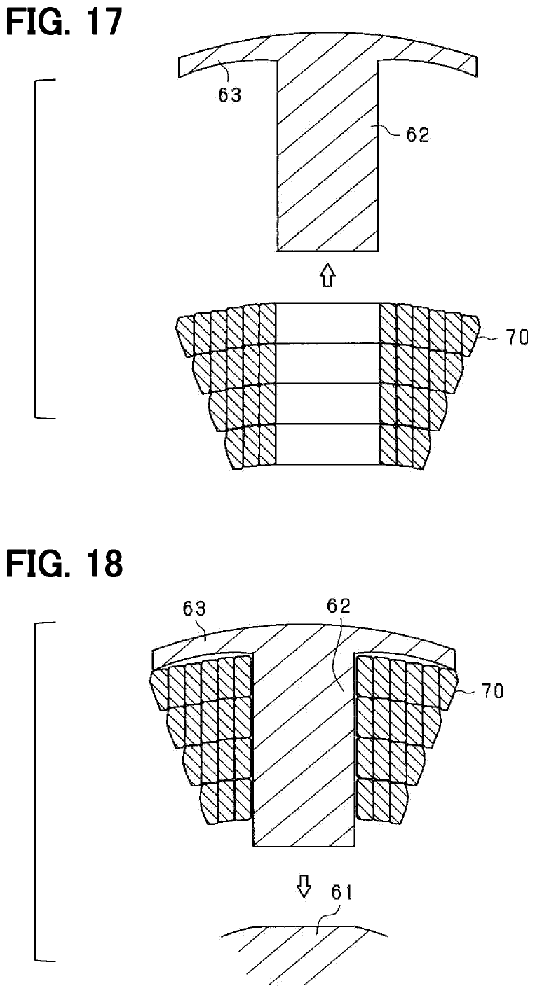

The flange portion 63 and the main pole portion 62 may be one main pole member, and the main pole member and the rotor core 61 may be separate members. In this case, in step S14 of FIG. 5, the field winding 70 is inserted into the main pole portion 62 as shown in FIG. 17. Then, in step S15, the main pole member in which the field winding 70 is inserted is attached to the rotor core 61, as shown in FIG. 18.

### Second Embodiment

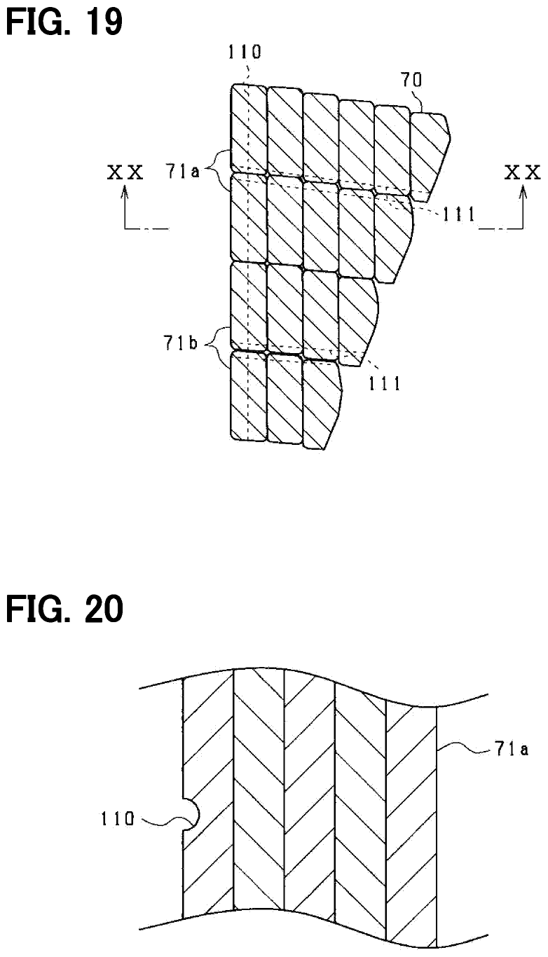

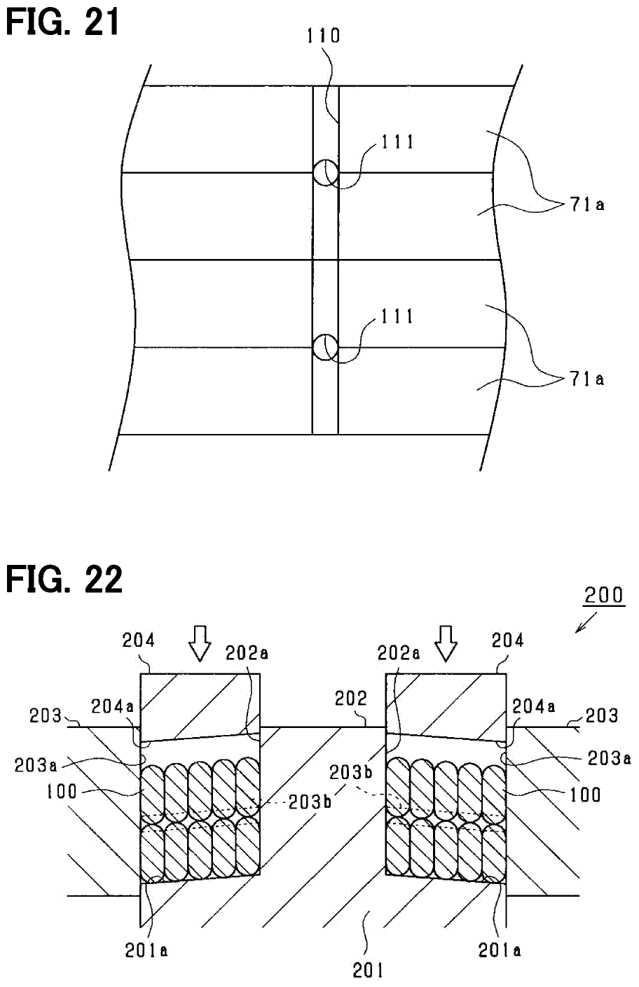

Hereinafter, a second embodiment will be described with reference to the drawings, focusing on differences from the first embodiment. In this embodiment, cooling passages are formed in the field winding 70. The cooling passages will be described below with reference to FIGS. 19 to 21. FIG. 19 shows a cross-sectional view of one side portion of the field winding 70 wound on the main pole portion 62. FIG. 20 is a cross-sectional view taken along line XX-XX of FIG. 19. FIG. 21 is a view of the field winding 70 of FIG. 19 viewed from the main pole portion 62 side.

A groove portion 110 extending from one end to the other end of the field winding 70 in the radial direction is formed in a portion of the field winding 70 facing the main pole portion 62. One or a plurality of groove portions 110 are formed. A radially extending cooling passage is formed by the main pole portion 62 and the groove portion 110. Thereby, the temperature rise of the field winding 70 and the main pole portion 62 due to the energization of the field winding 70 can be suppressed.

A cooling passage 111 extending from one end to the other end of the field winding 70 in the circumferential direction is formed in the field winding 70. FIGS. 19 and 21 show an example in which two cooling passages 111 are formed. The cooling passages 111 can suppress the temperature rise of the field winding 70.

In the present embodiment, since the space factor is enhanced, it is difficult for the cooling fluid to enter between the adjacent rectangular wires or between the rectangular wire and the main pole portion 62. Therefore, the advantage of providing the cooling passage is great.

In this case, the rotating electric machine 40 may have an air-cooled structure or an oil-cooled structure. In the case of the oil-cooled structure, cooling oil is sealed in the housing 41 of the rotating electric machine 40 and flows the cooling passages formed by the main pole portion 62 and the groove portions 110 and the cooling passages 111.

In the present embodiment, the cooling passages 111 are formed in the air-core coil 100 in the first pressing process or the third pressing process, and the groove portions 110 are formed in the second pressing process.

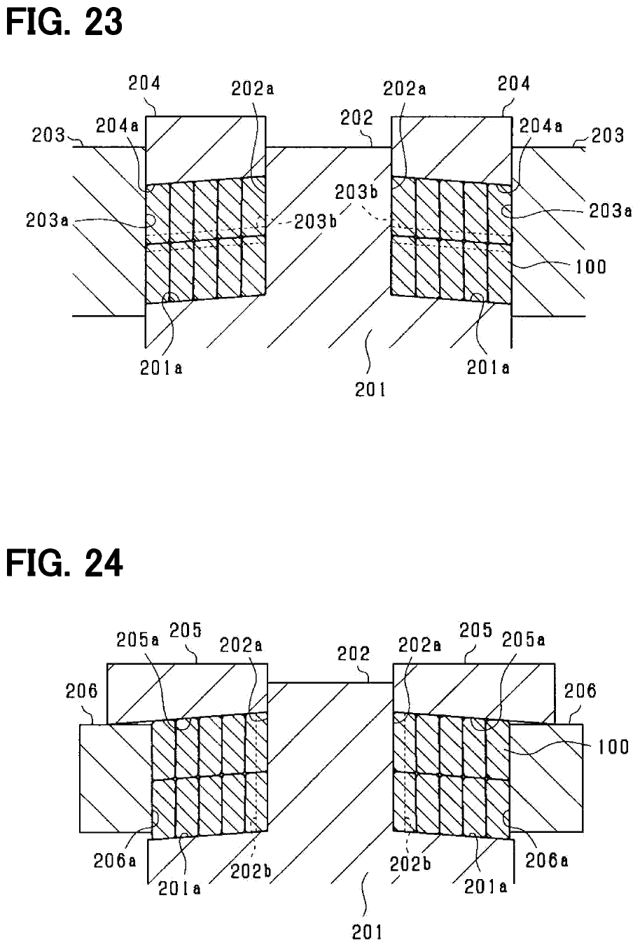

Taking the first pressing process as an example, as shown in FIG. 22, the first movable die 203 is provided with a cylindrical protruding portion 203b extending from an end surface 203a toward the base portion 202 side. As shown in FIG. 23, the linear portion 101 is compressed from above by the second movable die 204 in a state in which the protruding portion 203b is sandwiched between the rectangular wires arranged in the direction in which the base portion 202 extends. Thereby, the cooling passage 111 is formed in the air-core coil 100.

The second pressing process will be explained. As shown in FIG. 24, on a side surface 202a of the base portion 202 with which an inner surface of the air-core coil 100 abuts, a convex portion 202b extending along the extending direction of the base portion 202 and forming the groove portion 110 is formed. The fourth movable die 206 compresses the linear portion 101 from the lateral side. Thereby, the groove portions 110 are formed in the air-core coil 100.

In the present embodiment, the cooling structure is formed in the field winding 70 in the pressing process. Therefore, the time required to manufacture the field winding 70 with improved cooling efficiency can be shortened.

### Other Embodiments

The above embodiments may be changed and carried out as follows.

The capacitor 90 forming the resonance circuit may be connected in parallel to the first winding portion 71a instead of the second winding portion 71b. Also, the cathode and anode of the diode 80 may be connected in opposite directions. Specifically, referring to FIG. 4, the anode of the diode 80 may be connected to one end of first winding portion 71a, and the cathode of the diode 80 may be connected to one end of second winding portion 71b.

The rotating electric machine is not limited to the inner rotor type rotating electric machine, and may be an outer rotor type rotating electric machine. In this case, the main pole portion protrudes radially inward from the rotor core.

The rotating electric machine is not limited to a star-connected rotating electric machine, and may be a delta-connected rotating electric machine.

The stator core may be a stator core having no teeth.

The configuration for passing the field current through the field winding is not limited to the circuit shown in FIG. 4, for example, may be a configuration having a brush electrically connected to the field winding and a power supply. In this case, there is no need to apply harmonic voltages to the stator winding to induce field currents.

The rotating electric machine is not limited to a rotating electric machine used as a vehicle-mounted main machine, and may be, for example, a rotating electric machine used as an ISG (Integrated Starter Generator) that has function as a motor and generator.

The mobile object on which the control system is mounted is not limited to a vehicle, and may be, for example, an aircraft or a ship. Further, the control system is not limited to a system mounted on a moving body, and may be a system mounted on a stationary body.

What is claimed is:

1. A rotating electric machine, comprising:
a stator;
a rotor having a rotor core and main pole portions that are provided at predetermined intervals in a circumferential direction and protrude radially from the rotor core toward the stator, and
a field winding wound around each of the main pole portions, wherein
a center axis of the main pole portion extending in a radial direction passing through a rotation center axis of the rotor is defined as a first axis,
an axis passing through a center position in the circumferential direction of the first axis adjacent in the circumferential direction and the rotation center axis and extending in a radial direction is defined as a second axis,
an axis passing through a center position in the circumferential direction of the first axis and the second axis that are adjacent in the circumferential direction and the rotation center axis and extending in the radial direction is defined as a third axis, and
an outer end portion of the field winding in the circumferential direction in each of the main pole portions is positioned between the second axis and the third axis in the circumferential direction.

2. The rotating electric machine according to claim 1, wherein
the field winding is configured by multiple windings of rectangular wires so that the rectangular wires are arranged in the radial direction and the circumferential direction, and
in each of the main pole portions, an inclined portion inclined along the second axis is formed at the outer end portion of the field winding in the circumferential direction.

3. The rotating electric machine according to claim 2, wherein
a circumferential length dimension of a contact portion between the rectangular wires adjacent to each other in the radial direction is defined as WF,
a circumferential length dimension of the rectangular wire is defined as WT, and WF and WT are set so as to satisfy 0.2≤WF/WT<1.

4. The rotating electric machine according to claim 2, wherein
a groove portion extending from one end to the other end of the field winding in the radial direction is formed in a portion of the field winding facing the main pole portion.

5. A method for manufacturing the rotating electric machine according to claim 2, comprising:
a step of preparing an air-core coil that is formed by winding a rectangular wire in multiple layers, includes a pair of linear portions facing a side surface in the radial direction of the main pole portion and a transition portion connecting ends of the pair of linear portions, and has an annular shape in a plan view;
a step of preparing a base portion simulating the main pole portion and a movable die constructing a press molding device;
a step of inserting the air-core coil into the base portion;
a step of forming an inclined portion at an outer end portion of the air-core coil by pressing the movable die against the linear portion from an outer surface side to an inner surface side of the linear portion, in a state where an inner surface of the linear portion in contact with an outer surface of the base portion; and
a step of inserting the air-core coil formed with the inclined portion into the main pole portion as the field winding.

6. A method for manufacturing the rotating electric machine according to claim 4, comprising:
a step of preparing an air-core coil that is formed by winding a rectangular wire in multiple layers, includes a pair of linear portions facing a side surface in the radial direction of the main pole portion and a transition portion connecting ends of the pair of linear portions, and has an annular shape in a plan view;
a step of preparing a base portion that simulates the main pole portion, constructs a press molding device, and has a convex portion extending along a direction perpendicular to the linear portion of the air-core coil at a portion with which the inner surface of the air-core coil abuts so as to form the groove portion; a step of preparing a movable die constructing the press molding device; a step of inserting the air-core coil into the base portion;
a step of forming an inclined portion at an outer end portion of the air-core coil and forming the groove portion at an inner end portion of the air-core coil by pressing a movable die constructing the press molding device against the linear portion from an outer surface side to an inner surface side of the linear portion, in a state where an inner surface of the linear portion in contact with an outer surface of the base portion; and
a step of inserting the air-core coil formed with the inclined portion and the groove portion into the main pole portion as the field winding.

7. A method for manufacturing the rotating electric machine, in which the field winding is configured by multiple windings of the rectangular wires so that the rectangular wires are arranged in the radial direction and the circumferential direction, according to claim 1, comprising:
a step of preparing an air-core coil that is formed by winding a rectangular wire in multiple layers, includes a pair of linear portions facing a side surface in the radial direction of the main pole portion and a transition portion connecting ends of the pair of linear portions, and has an annular shape in a plan view;
a step of preparing a base portion extending upward from a mounting surface of a base portion constructing a press molding device and simulating the main pole portion and a movable die constructing the press molding device;
a step of inserting the air-core coil into the base portion and placing the air-core coil on the mounting surface;
a circumferential direction compressing step of compressing each of the linear portions in a direction in which the pair of linear portions face each other by pressing a movable die constructing the press molding device against the linear portion from an outer surface side to an inner surface side of the linear portion, in a state where an inner surface of the linear portion is in contact with an outer surface of the base portion;
a radial direction compressing step of compressing each of the linear portions in a direction orthogonal to a direction in which the linear portion extends by pressing the movable die against the linear portion from the side opposite to the mounting surface side of the linear portion, in a state where the linear portion is in contact with the mounting surface; and
a step of inserting the air-core coil for which the circumferential direction pressing step and the radial direction pressing step are completed into the main pole portion as the field winding.
